(19) United States
(12) Patent Application Publication
(10) Pub. No.: US 2003/0198329 A1
(43) Pub. Date: Oct. 23, 2003

(54) System and method for monitoring third party callers

(76) Inventor: Leo Craig McGee, Los Angeles, CA (US)

Correspondence Address: LACASSE & ASSOCIATES, LLC, 1725 DUKE STREET, SUITE 650, ALEXANDRIA, VA, 22314, US

(21) Appl. No.: 10/124,361

(22) Filed: Apr. 18, 2002

(51) Int. Cl. H04M 3/42

(52) U.S. Cl. 379/202.01; 379/207.01

(57) ABSTRACT

A three-way communication session is established between a first and a second party, wherein the first party is additionally connected to a third party via a previously established communication. An indication (such as the telephone number associated with the third party, an alphanumeric character, or an icon) is then transmitted to the second party to notify him/her of the presence of the third party in the three-way communication session.

### BACKGROUND OF THE INVENTION

1. Field of Invention

The present invention relates generally to the field of telecommunications. More specifically, the present invention is related to caller identification and three-way calling.

2. Discussion of Prior Art

FIG. 1 illustrates a prior art scenario wherein a first called party is able to listen in on a conversation between a caller and a second called party without revealing his/her identity. In this example, caller X (phone number 555-1111) 102 initiates a call to party Y (phone number 555-2222) 104 and establishes a communication link with called party Y 104. Next, caller X 102 puts called party Y 104 on hold and, via a second dial tone, initiates a three-way call to another called party Z (phone number 555-3333) 106. Current systems offer a caller ID unit (stand-alone or integrated with a telephone) 108 that can be used at called party Z's 106 end wherein the unit displays information related to an incoming call (e.g., name of the caller and telephone number of caller). Thus, the caller ID unit 108 of called party Z 106 displays the phone number of the incoming caller (555-1111), but called party Z 106 is unaware of additional called parties such as caller Y 104 who is listening in on the conversation.

To help better understand the disadvantage associated with the above-mentioned prior art, a real-life scenario is described. In this example, Amber calls her friend Lynn and asks her to listen in on a three-way call she is about to place to Nancy. Once the three-way call is established, Nancy is completely unaware that Lynn is listening to the conversation. Nancy may provide personal or confidential information that she might not provide if she knew someone else was listening.

The following references describe prior art systems providing three-way calling and caller identification information.

The patent to Eaton et al. (U.S. Pat. No. 5,483,588), assigned to Latitute Communications, provides for a voice-processing interface for a teleconference system. Described within is a method for controlling a new caller's access to an existing conference call. New callers attempting to join an ongoing conference call are prompted to enter their identification.

The patent to Lewis (U.S. Pat. No. 5,583,924), assigned to CIDCO Incorporated, provides for a caller ID and call waiting for multiple CPES on a single telephone line.

The patent to Yaker (U.S. Pat. No. 5,784,448), assigned to Lucent Technologies Inc., provides for an advanced call waiting processing. Described within is a method for managing call waiting in which a three-way conference call is controlled by the called party. Mentioned within is an embodiment where the second party in the first call is informed of an incoming call and prompted to choose to either admit or deny a third party in a three-way conference call.

The patent to Richardson, Jr. et al. (U.S. Pat. No. 5,883,945), assigned to United States Advanced Networks, Inc., provides for a three-way call detection and response system. Described within is a method for informing a caller that a three-way call is taking place at the called party's phone. However, there is no mention of identifying the parties involved in the conference call.

The patent to Johnson (U.S. Pat. No. 6,141,406), assigned to T-Netix, Inc., provides for a method and apparatus for detecting a secondary destination of a telephone call based on changes in the telephone signal path. Discussed within is a method for detecting whether one party in a two-way telephone call has initiated a three-way call. Echo conditions are used to detect that occurrence.

The patent to Tsaul et al. (RE 34,735), assigned AT&T Bell Laboratories, provides for a call waiting arrangement providing options to both a sub calling party and to the called party. Described within is a method for informing the caller of an incoming call that the called party is busy in another call. The caller is provided with the options of interrupting the call, waiting until the call clears, or disconnecting the call.

The patent to Mumford (WO 9853591), assigned to MCI Communications Corporation, provides for a method and apparatus for enhanced call waiting in a telecommunications network. Described within is a method for managing call waiting that notifies callers as well as called parties. A calling party is informed of the current status of the called party (busy line) and is provided with an option of joining a three-way conversation.

Whatever the precise merits, features and advantages of the above cited references, none of them achieve or fulfills the purposes of the present invention.

### BRIEF DESCRIPTION OF THE DRAWINGS

FIG. 1 illustrates a prior art scenario wherein a first called party is able to listen in on a conversation between a caller and a second called party without revealing his/her identity.

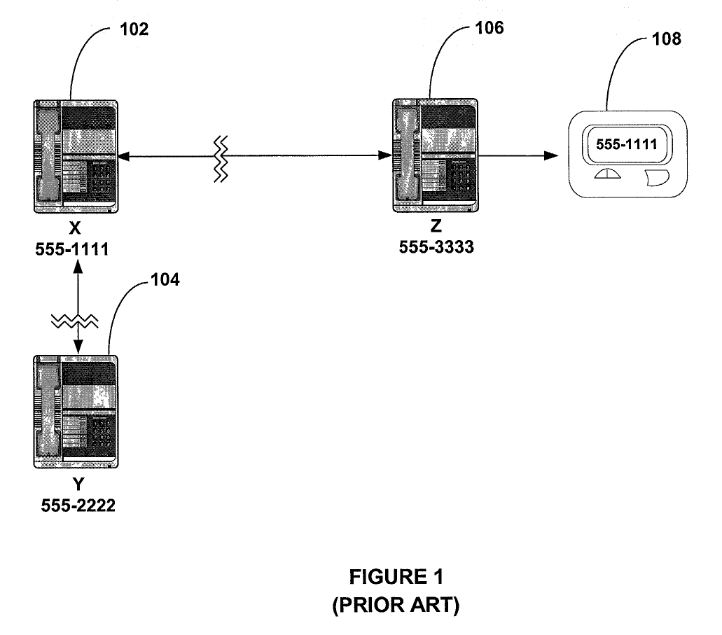

FIG. 2 illustrates an example showing the present invention's enhancement to a three-way call session.

FIG. 3 illustrates the present invention's enhancement in a multi-party communication session.

FIG. 4 illustrates a method associated with the present invention.

### DESCRIPTION OF THE PREFERRED EMBODIMENTS

While this invention is illustrated and described in a preferred embodiment, the invention may be produced in many different configurations, forms, and materials. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

The present invention provides for a system and method for identifying all parties involved in a three-way or multi-party call scenario. This improvement over the prior art is accomplished via a software upgrade at the central telecommunications office, with minimal changes at the consumer's end. The present invention provides significant protection from an unexpected person (or persons) being unknowingly connected to a third party (i.e., via three-way calling).

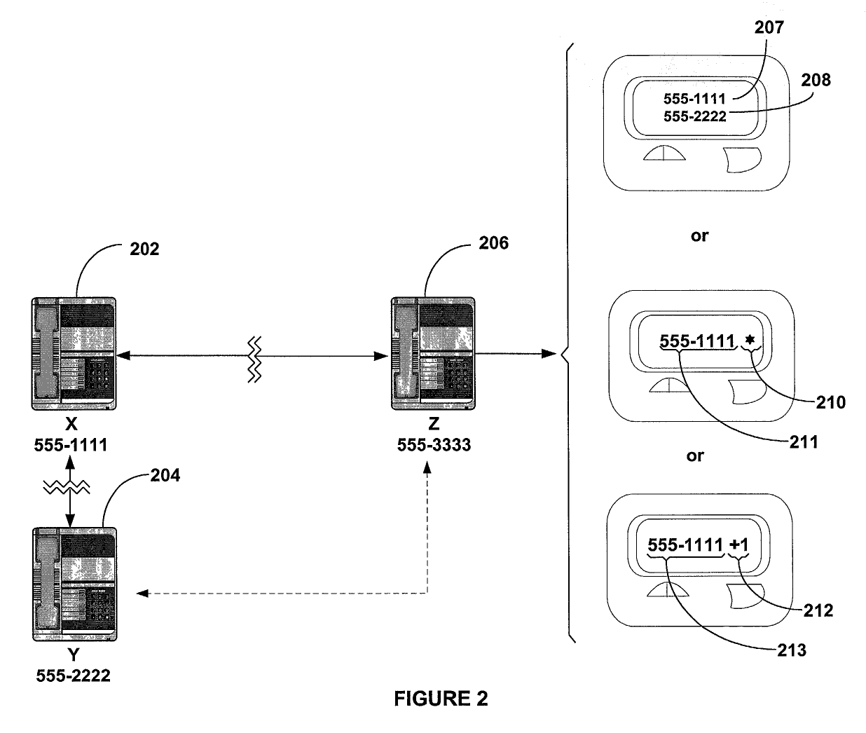

FIG. 2 illustrates an example showing the implementation of the present invention system in a three-way call scenario. In this example: caller X 202 (caller X 202 subscribes to a three-way calling plan) establishes a communication link with party Y 204, proceeds to put party Y 204 on hold, and then places a three-way call to party Z 206 via a second dial tone. In this scenario, the present invention's system allows called party Z 206 to view caller identification information related not only to caller X 202, but also an indication identifying any additionally connected parties (such as party Y 204) in communication with caller X 202. In an alternative embodiment, the primary caller (caller X) waits until party Z answers the phone before connecting him/her with party Y, who is on hold. It should be noted that caller identification doesn't work in this scenario. However, in this embodiment, when caller X uses flash to connect all parties in a communication session, party Z gets a low beep tone or double beep tone indicating the presence of caller Y.

Various ways are envisioned for identifying the extra caller. For example, in one embodiment, Y's telephone number 208 is displayed (via a device implementing the present invention) under, or adjacent to, the primary caller's (caller X's) number 207. In another embodiment, an icon 210 is placed at the end of the primary caller's (caller X's) number 211. In a specific example, the LCD screen on caller Z's display device (e.g., a caller ID unit implementing the present invention) displays the phone number (555-1111) of caller X (the person who initiated the communication) and one or more icons indicating (to caller Z) the presence of an another called party (caller Y) connected to the call in addition to caller X.

In yet another embodiment, one or more extra characters 212 are placed at the end of the primary caller's (caller X's) number 213. For example, if there is one additional caller connected to caller X, the characters “+1” are added to the caller identification information of caller X, which now reads “555-1111+1” or “555-1111 (1)”. This information is rendered at caller Z's 206 end via a display device (e.g., caller ID unit) implementing the present invention.

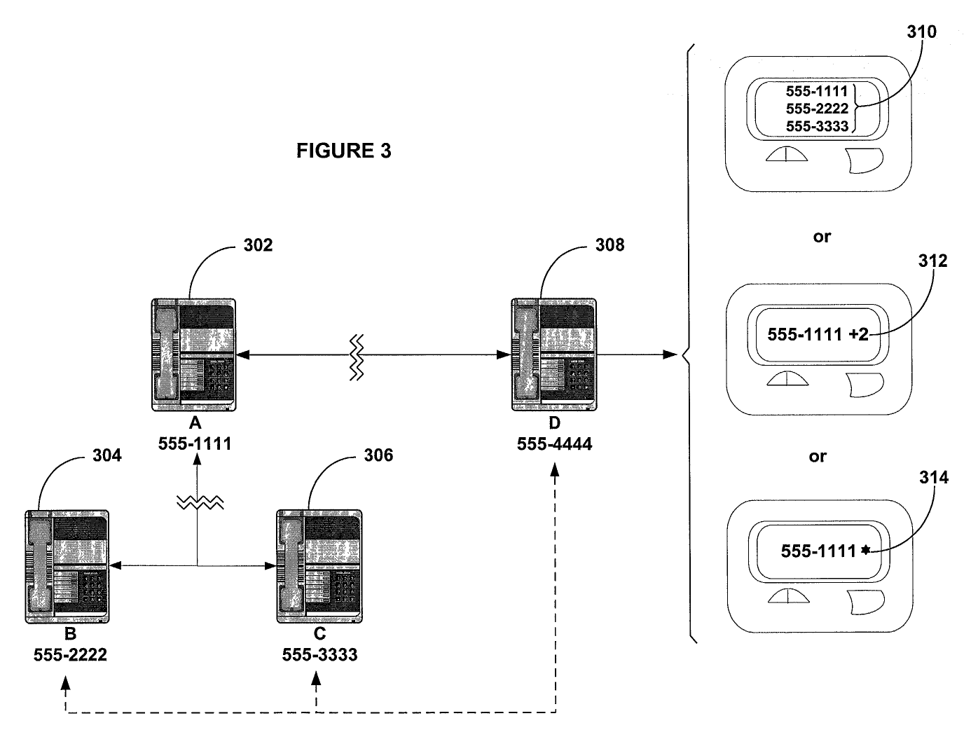

FIG. 3 illustrates the implementation of the present invention in a multi-party call scenario wherein one of the multi-party call participants initiates a call to an external called party. In this scenario, A 302, B 304, and C 306 are part of a multi-party call, when caller A places them on hold and initiates a call to called party D 308. In the prior art scenario, D 308 is unaware of the identity of B 304 and C 306. The present invention, on the other hand, allows for an indication to be displayed to D 308 regarding the presence of B 304 and C 306 in the communication loop. The indication, as mentioned above, can be: (a) caller identification information related to A, B, and C 310; (b) caller ID information of A with appended characters 312; or (c) an icon 314 indicating the presence of more than just caller A in the communication session. In this instance, since two parties (B and C) are connected to A, the characters “+2” or “(2)” are appended to the caller identification information of caller A, which now reads “555-2222+2” or “555-2222(2)” 312. This caller identification information with the appended characters is then rendered at D's end via a device (standalone or integrated with a telecommunication device), such as a caller ID unit implementing the present invention.

It should be noted that although in one embodiment a specific example of an icon is used to indicate when three-way calling occurs, one skilled in the art can envision using other icons or visual indications without departing from the scope of the present invention. Furthermore, although in various embodiments, the caller identification information is rendered via a caller ID unit, one skilled in the art can envision using other devices that is standalone or integrated with a telecommunication device. Additionally, the telecommunication device that implements the present invention's enhancement to caller identification information can be any of (but is not limited to) the following: POTS-based telephone, wireless telephone, cellular telephone, or Internet telephone. Furthermore, it should be noted that there are no limits to the total number of calls that can be identified with this feature. For example, in the instance that there is more than one caller, the last digit could change to 1, 2, 3, etc.

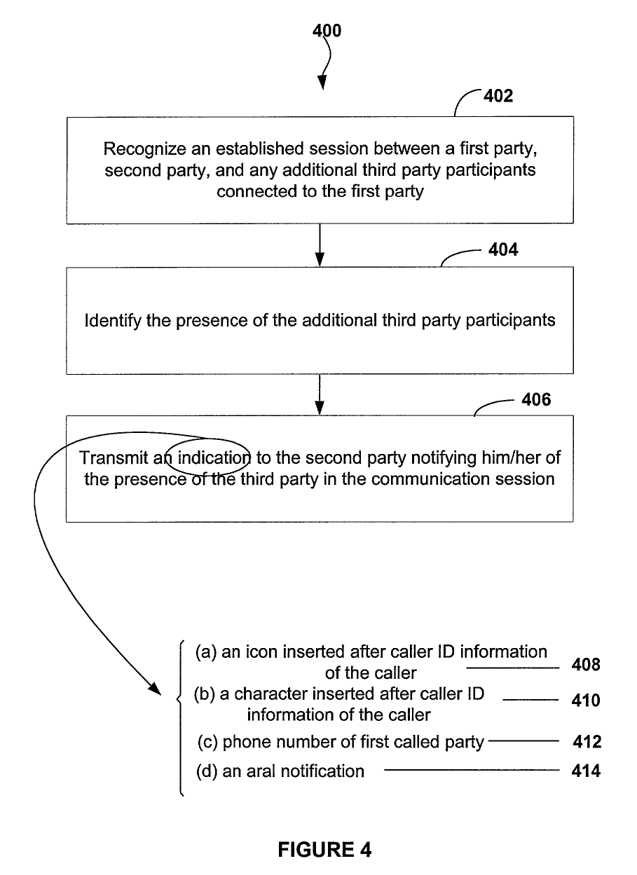

FIG. 4 illustrates a method 400 of the present invention for enhancing a multi-party communication session established between a first party, second party, and any additional third party participants connected to said first party. In step 402, the established session is recognized, and in step 404, the presence of any additional third party participants are identified. In step 406, an indication is transmitted to the second party notifying him/her of the presence of the third party in the communication session. The transmitted indication can be any of, or a combination of the following: (a) if no caller identification information is available for the additional third party participants, then an icon is transmitted 408 to the second party indicating the presence of the additional third party participants in said communication session; (b) the total number of third party participants in the multi-party communication session is determined and transmitted 410 to the second party; (c) if caller identification information regarding each of the third party participants is available, then the identification information is transmitted 412 to the second party; and/or (d) an aural notification 414 is transmitted to indicate the presence of third party participants.

Furthermore, the present invention includes computer program code, which is stored on a storage medium and which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage device.

Implemented in computer readable program code are software modules for: recognizing an established multi-party communication session between a first party, second party, and any additional third party participants connected to the first party; identifying the presence of additional third party participants in the multi-party communication session, and performing one or more of the following steps to notify the second party: (a) if no caller identification information is available for the additional third party participants, then an icon is transmitted to the second party indicating the presence of additional third party participants in the communication session; (b) determining the total number of third party participants in the multi-party communication session and transmitting the number to the second party; (c) if caller identification information regarding each of the third party participants is available, then the identification information is transmitted to the second party; and/or (d) transmitting an aural indication indicating the presence of third party participants in the communication session.

Conclusion

A system and method have been shown in the above embodiments for identifying the presence of third party callers. While various preferred embodiments have been shown and described, it will be understood that there is no intent to limit the invention by such disclosure, but rather, it is intended to cover all modifications and alternate constructions falling within the spirit and scope of the invention, as defined in the appended claims. For example, the present invention should not be limited by type of rendered characters used for identification of third party callers, type of icon used in identification of third party callers, location of icon or third party information in a display device, software/program, or specific hardware.

1. A method for enhancing a multi-party communication session established between a first party, second party, and any additional third party participant(s) connected to said first party, said method comprising the steps of:
a. recognizing said established session; and
b. identifying the presence of said additional third party participant(s) in said multi-party communication session;
c. providing notice to said second party regarding the presence of said additional third participant(s) in said communication session.

2. A method as per claim 1, wherein said step of providing notice is done via transmitting an icon to said second party indicating the presence of said additional third party participant(s) in said communication session.

3. A method as per claim 1, wherein said step of providing notice is done via transmitting, to said second party, a number indicating the total number of third party participant(s) in said multi-party communication session.

4. A method as per claim 1, wherein said step of providing notice is done via transmitting, to said second party, identification information associated with said third party participant(s).

5. A method as per claim 1, wherein said step of providing notice is done via transmitting, to said second party, an aural notification indicating the presence of third party participant(s).

6. A method for enhancing a multi-party communication session established between a first party, second party, and any additional third party participant(s) connected to said first party, said method comprising the steps of:
a. recognizing said established session; and
b. identifying the presence of said additional third party participant(s) in said multi-party communication session, and performing one or more of the following steps to provide notice to said second party:
i. if no caller identification information is available for said additional third party participant(s), then transmitting an icon to said second party indicating the presence of said additional third party participant(s) in said communication session; or
ii. determining the total number of third party participant(s) in said multi-party communication session and transmitting said number to said second party; or
iii. if caller identification information regarding each of said third party participant(s) is available, then transmitting said identification information to said second party.

7. A method as per claim 6, wherein said steps of providing notice to said second party further comprises the step of transmitting an aural notification to said second party indicating the presence of said additional third party participant(s) in said communication session.

8. A method for enhancing a three-way call session established between a first party, second party, and a third party connected to said first party, said method comprising the steps of:
a. recognizing said established session, and
b. identifying the presence of said third party in said session, and performing one or more of the following steps to provide notice to said second party:
i. if no caller identification information is available for said third party, then transmitting an icon to said second party indicating the presence of said third party in said session; or
ii. transmitting an alphanumeric character appended to caller identification information of said first caller to indicate the presence of one caller in addition to said first caller in said session; or
iii. if caller identification information regarding said third party is available, then transmitting, to said second party, said identification information appended to caller identification information of said first caller.

9. A method as per claim 8, wherein said steps of providing notice to said second party further comprises the step of transmitting an aural notification to said second party indicating the presence of said additional third party in said session.

10. Computer readable program code for enhancing a multi-party communication session established between a first party, second party, and any additional third party participant(s) connected to said first party, said code comprising the steps of:
a. recognizing said established session; and
b. identifying the presence of said additional third party participant(s) in said multi-party communication session, and performing one or more of the following steps to provide notice to said second party:
i. if no caller identification information is available for said additional third party participant(s), then transmitting an icon to said second party indicating the presence of said additional third party participant(s) in said communication session; or
ii. determining the total number of third party participant(s) in said multi-party communication session and transmitting said number to said second party; or
iii. if caller identification information regarding each of said third party participant(s) is available, then transmitting said identification information to said second party.

11. Computer readable program code for enhancing a multi-party communication session, as per claim 10, wherein said code further comprising the steps of transmitting an aural notification to said second party indicating the presence of said additional third party participant(s) in said communication session.
